(19) United States
(12) Patent Application Publication
(10) Pub. No.: US 2007/0234049 A1
(43) Pub. Date: Oct. 4, 2007

(54) Method and Apparatus for Enhancing Security of Data Processing

(76) Inventors: Chun-Hung Kuo, Taipei City (TW); Chih-Ming Tang, Kaohsiung County (TW)

Correspondence Address: NORTH AMERICA INTELLECTUAL PROPERTY CORPORATION, P.O. BOX 506, MERRIFIELD, VA, 22116, US

(21) Appl. No.: 11/423,150

(22) Filed: Jun. 9, 2006

(30) Foreign Application Priority Data
Mar. 30, 2006 (TW) 095111294

(51) Int. Cl. H04L 9/00; G06F 12/14; H04L 9/32; G06F 11/30

(52) U.S. Cl. 713/166; 713/189

(57) ABSTRACT

A method for enhancing data processing security intercepts a portion of data-to-be-transmitted, determines a security level of the data-to-be-transmitted according to the portion of the data-to-be-transmitted, and sets readability of the data-to-be-transmitted according to the security level of the data-to-be-transmitted.

### BACKGROUND OF THE INVENTION

1. Field of the Invention

The present invention relates to an apparatus for ciphering data-to-be-transmitted, and more particularly, to an apparatus for enhancing security of data processing.

2. Description of the Prior Art

Communications technology has been highly developed, so that more and more companies, enterprises, and administrations process data access through public communication channels. Different users can access the same data or file through a network. In order to protect important and confidential data from being released to the public, the prior art provides a method for encrypting data, that is, to transform readable data into unreadable data.

In the prior art, data-to-be-transmitted is transformed into encryption data, and then transmitted to a destination end, such as a storage device, through the public communication channels. Users who have authorization can retrieve or read content of the encryption data. However, encrypting data in the prior art must occupy operating resources of a CPU in a transmitter, causing work efficiency of the CPU to be decreased.

### SUMMARY OF THE INVENTION

It is therefore a primary objective of the claimed invention to provide a method and apparatus for enhancing security of data processing.

According to the claimed invention, a method for enhancing data processing security intercepts a portion of data-to-be-transmitted, determines a security level of the data-to-be-transmitted according to the portion of the data-to-be-transmitted, and sets readability of the data-to-be-transmitted according to the security level of the data-to-be-transmitted.

According to the claimed invention, a data processing device capable of enhancing data security comprises a central processing unit in electrical communications with a memory. The memory comprises program code for implementing the above-mentioned method.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates a schematic diagram of a data processing device capable of enhancing data processing security in accordance with the present invention.

FIG. 2 illustrates a flowchart of a process for enhancing data processing security in accordance with the present invention.

### DETAILED DESCRIPTION

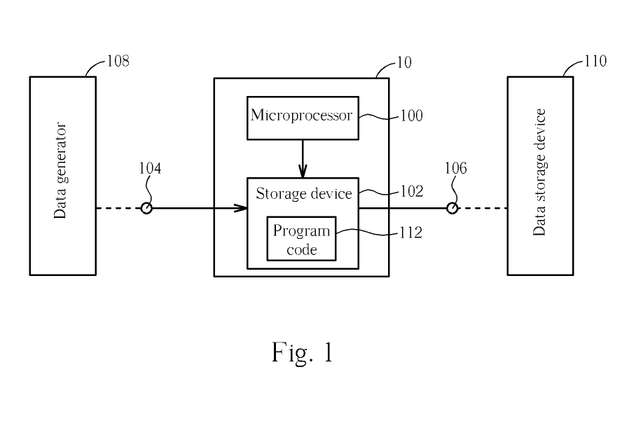

Please refer to FIG. 1, which illustrates a schematic diagram of a data processing device 10 capable of enhancing data processing security in accordance with the present invention. The data processing device 10 includes a microprocessor 100, a storage device 102, a data reception end 104, and a data output end 106. The storage device 102 stores program code 112. The microprocessor 100 performs commands or operations of the program code 112, so as to receive data-to-be-transmitted generated by a data generator 108 through the data reception end 104, to determine a security level of the data-to-be-transmitted, to encrypt or keep the data-to-be-transmitted unchanged, and to transmit the data-to-be-transmitted to a data storage device 110 through the data output end 106. Therefore, while executing the program code 112, the microprocessor 100 determines whether the data-to-be-transmitted needs to be encrypted or not. As a result, the data generator 108 need not to perform encrypting operations, and decreases the workload accordingly.

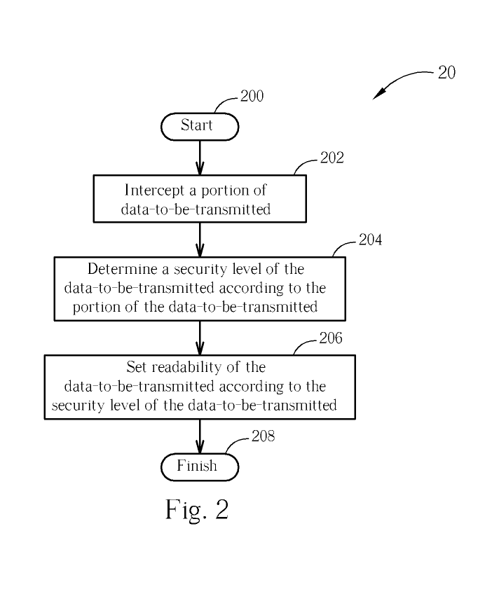

Please refer to FIG. 2, which illustrates a flowchart of a process 20 for enhancing data processing security in accordance with the present invention. The program code 112 can implement the process 20. The process 20 includes following steps:
Step 200: start.
Step 202: intercept a portion of data-to-be-transmitted.
Step 204: determine a security level of the data-to-be-transmitted according to the portion of the data-to-be-transmitted.
Step 206: set readability of the data-to-be-transmitted according to the security level of the data-to-be-transmitted.
Step 208: finish.

Therefore, according to the process 20, the present invention intercepts the portion of the data-to-be-transmitted, and determines whether the data-to-be-transmitted is confidential data or not, and sets the readability of the data-to-be-transmitted. For example, if the data-to-be-transmitted is high-security data, the data-to-be-transmitted is encrypted and transmitted to the data storage device 110. Therefore, users who have no authorization cannot retrieve content of the data. Oppositely, if the data-to-be-transmitted is not confidential data, such as commands or control signals, the data-to-be-transmitted is not encrypted and is transmitted to the data storage device 110 directly. In short, the process 20, which can be implemented by the program code 112, can encrypt or directly transmit data to the data storage device 110 without using resources of the data generator 108.

Therefore, the data processing device 10 can encrypt data, and work efficiency of the data generator 108 can be maintained. The data generator 108 can be any device utilized for generating data or performing data processing, such as computer hosts, notebook computers, portable mobile devices, microprocessors, interface cards, or routers. The data storage device 108 can be a hard disk device, a magnetic storage device, a card reader, a writeable disc drive, a digital video recorder, or a flash memory card.

In FIG. 1, the data processing device 10 is installed between the data generator 108 and the data storage device 110. That is, the data processing device 10 is like a bridge for exchanging signals between the data storage device 110 and the data generator 108, so that the data processing device 10 can perform encrypting without using resources of a CPU in the data generator 108. In this case, for the data storage device 110, the data processing device 10 is a virtual data generator, and for the data generator 108, the data processing device 10 is a virtual data storage device, as if there is no device between the data storage device 110 and the data generator 108. Therefore, data communication between the data storage device 110 and the data generator 108 is unhindered. In addition, the data processing device 10 can be installed inside the data generator 108 or the data storage device 110 and in front of a communication interface of the data storage device 110 or the data generator 108, so that control circuits of the data generator 108 or the data storage device 110 need not change, but are available to the present invention. Furthermore, the present invention can be suitable for not only communication between single host and a storage as mentioned above, but also communication of local area networks, Internet, etc.

In summary, the present invention can encrypt data without using resources of the data generator. Therefore, work efficiency of the data generator can be increased.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for enhancing data processing security comprising:
intercepting a portion of data-to-be-transmitted;
determining a security level of the data-to-be-transmitted according to the portion of the data-to-be-transmitted; and
setting readability of the data-to-be-transmitted according to the security level of the data-to-be-transmitted.

2. The method of claim 1, wherein setting the readability of the data-to-be-transmitted according to the security level of the data-to-be-transmitted comprises encrypting the data-to-be-transmitted when the data-to-be-transmitted is high-security data.

3. The method of claim 1, wherein setting the readability of the data-to-be-transmitted according to the security level of the data-to-be-transmitted comprises keeping the data-to-be-transmitted unchanged when the data-to-be-transmitted is not high-security data.

4. The method of claim 1 further comprising receiving the data-to-be-transmitted from a data generator.

5. The method of claim 4, wherein the data generator is a computer host, a notebook computer, a portable mobile device, a microprocessor, an interface card, or a router.

6. The method of claim 1 further comprising transmitting the data-to-be-transmitted to a data storage device.

7. The method of claim 1, wherein the data storage device is a hard disk device, a magnetic storage device, a card reader, a writeable disc drive, a digital video recorder, or a flash memory card.

8. A data processing device capable of enhancing data security comprising a central processing unit in electrical communications with a memory, the memory comprising program code for implementing the method of claim 1.
